(19) United States
(12) Patent Application Publication
(10) Pub. No.: US 2012/0327014 A1
(43) Pub. Date: Dec. 27, 2012

(54) TOUCH-SENSITIVE DISPLAY AND ELECTRONIC DEVICE INCLUDING SAME

(75) Inventors: John Edward DOLSON, Carp (CA); James Alexander ROBINSON, Elmira (CA); Amit Pal SINGH, Waterloo (CA); Christopher Ying Wai HO, Markham (CA); Kevin Paul TIMMERMAN, Elmira (CA)

(73) Assignee: RESEARCH IN MOTION LIMITED, Waterloo (CA)

(21) Appl. No.: 13/168,139

(22) Filed: Jun. 24, 2011

(51) Int. Cl. G06F 3/045; G09G 3/36

(52) U.S. Cl. 345/174; 345/104

(57) ABSTRACT

A touch-sensitive display includes a display, a capacitive touch sensor disposed on the display, a cover spaced from the capacitive touch sensor, and a liquid disposed in a cavity between the capacitive touch sensor and the cover.

### FIELD OF TECHNOLOGY

The present disclosure relates to touch-sensitive displays including, but not limited to, portable electronic devices having touch-sensitive displays.

### BACKGROUND

Electronic devices, including portable electronic devices, have gained widespread use and may provide a variety of functions including, for example, telephonic, electronic messaging and other personal information manager (PIM) application functions. Portable electronic devices include several types of devices including mobile stations such as simple cellular telephones, smart telephones (smart phones), Personal Digital Assistants (PDAs), tablet computers, and laptop computers, with wireless network communications or near-field communications connectivity such as Bluetooth® capabilities.

Portable electronic devices such as PDAs, or tablet computers are generally intended for handheld use and ease of portability. Smaller devices are generally desirable for portability. A touch-sensitive display, also known as a touchscreen display, is particularly useful on handheld devices, which are small and may have limited space for user input and output. The information displayed on the display may be modified depending on the functions and operations being performed.

Improvements in electronic devices with displays are desirable.

### BRIEF DESCRIPTION OF THE DRAWINGS

FIG. 1 is a block diagram of a portable electronic device in accordance with an example embodiment.

FIG. 2 is a cross section of a portable electronic device including a touch-sensitive display in accordance with the disclosure.

FIG. 3 is a cross section of a portable electronic device with a depressed touch-sensitive display in accordance with the disclosure.

FIG. 4 is a front view of a portable electronic device in accordance with the disclosure.

### DETAILED DESCRIPTION

The following describes an electronic device and a touch-sensitive display that includes a display, a capacitive touch sensor disposed on the display, a cover spaced from the capacitive touch sensor, and a liquid disposed within a cavity between the capacitive touch sensor and the cover.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, such as a portable electronic device or non-portable electronic device. Examples of portable electronic devices include mobile, or handheld, wireless communication devices such as pagers, cellular phones, cellular smart-phones, wireless organizers, personal digital assistants, wirelessly enabled notebook computers, tablet computers, mobile internet devices, and so forth. The portable electronic device may be a portable electronic device without wireless communication capabilities, such as handheld electronic games, digital photograph albums, digital cameras, media players, e-book readers, and so forth. Examples of non portable electronic devices include desktop computers, electronic white boards, smart boards utilized for collaboration, built-in monitors or displays in furniture or appliances, and so forth.

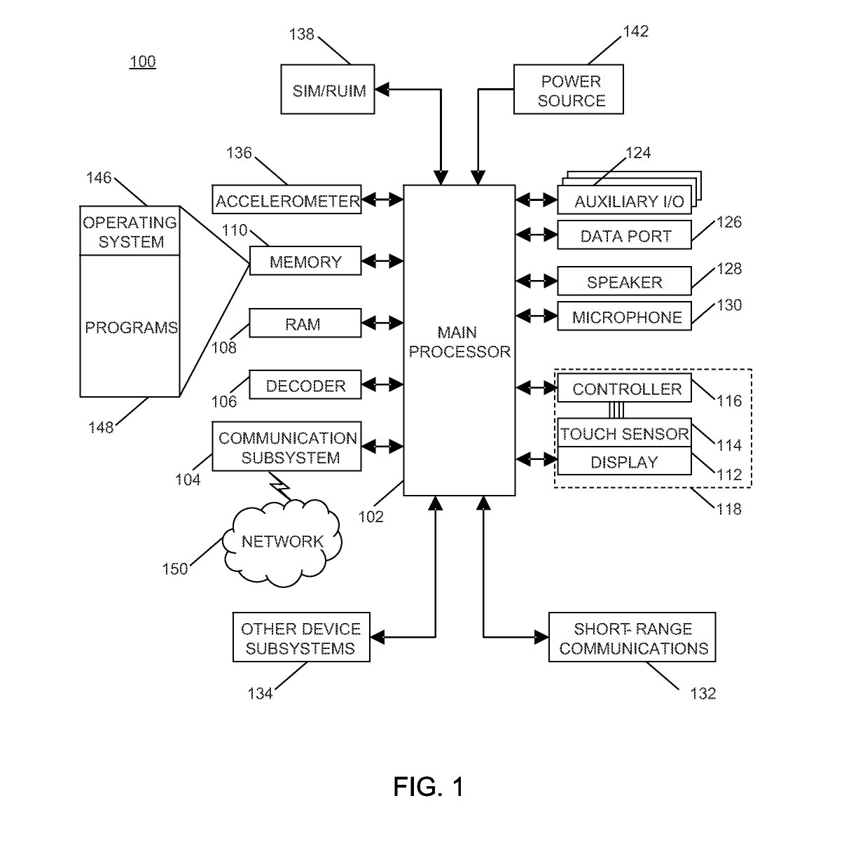

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a touch-sensitive display 118 which includes a display 112 with a touch sensor 114, which may be a touch-sensitive overlay, operably coupled to an electronic controller 116. The processor 102 also interacts with an auxiliary input/output (I/O) subsystem 124, a data port 126, a speaker 128, a microphone 130, short-range communications 132, and other device subsystems 134. User-interaction with a graphical user interface is performed through the touch sensor 114. The processor 102 interacts with the touch sensor 114 via the electronic controller 116. Information, such as text, characters, symbols, images, icons, and other items that may be displayed or rendered on a portable electronic device, is displayed on the touch-sensitive display 118 via the processor 102. The processor 102 may interact with an accelerometer 136 that may be utilized to detect direction of gravitational forces or gravity-induced reaction forces.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal, such as a text message, an e-mail message, or web page download, is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

The touch-sensitive display 118 may be any suitable capacitive touch-sensitive display, such as a self-capacitive or mutual capacitive touch-sensitive display, as known in the art. A capacitive touch-sensitive display includes a capacitive touch sensor 114. The touch sensor 114 may be an assembly of multiple layers in a stack including, for example, a substrate, a ground shield layer, a barrier layer, and one or more capacitive touch sensing layers, separated by a substrate or other barrier. The capacitive touch sensing layers may be any suitable material, such as patterned indium tin oxide (ITO) to provide sets of electrodes utilized for touch sensing. Alternatively, the layers of the touch sensor 114 may include a substrate, such as a glass substrate, and a layer including a set of electrodes on one side of the glass sheet or substrate. A second layer including a set of electrodes may optionally be included on an opposing side of the substrate.

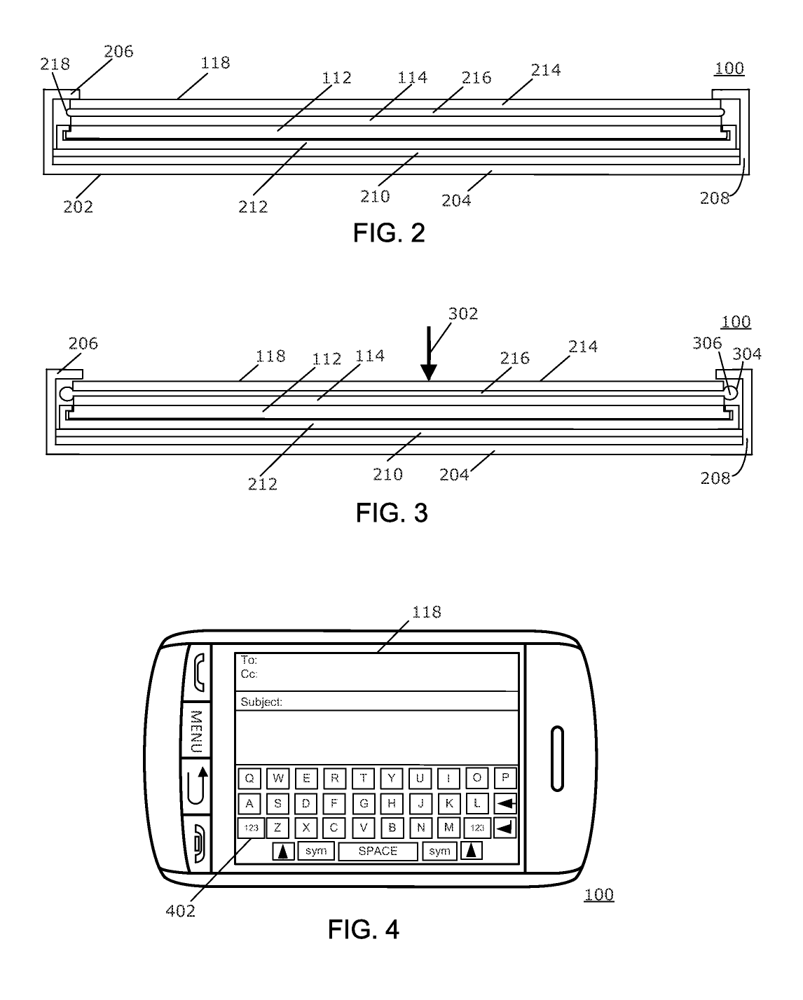

A cross section of a portable electronic device 100 taken through a center of the touch-sensitive display 118 is shown in FIG. 2. The portable electronic device 100 includes a housing 202 that encloses components such as shown in FIG. 1. The housing 202 may include a back 204, sidewalls 208, and a frame 206 that houses the touch-sensitive display 118. A base 210 extends between the sidewalls 208, generally parallel to the back 204. The display 112 and the touch sensor 114 are supported on a support tray 212 of suitable material, such as magnesium.

The display 112 may be any suitable display, such as a liquid crystal display (LCD), a light-emitting diode (LED) display, or an organic light-emitting diode (OLED) display.

The touch sensor 114 is disposed on the display 112 and may be adhered to the display 112, for example, utilizing an optically clear adhesive. The optically clear adhesive may be, for example, an adhesive sheet or tape, or a hardened or cured liquid adhesive.

A cover 214 is spaced from the touch sensor 114 by a bladder 216. The cover 214 may be a glass cover or polymeric material and may include, for example, a protective anti-reflective coating. The bladder 216 is a flexible bag or container of suitable translucent or transparent material such as, for example, silicone or flexible plastic. A liquid is disposed in the bladder 216 that is located in a cavity between the cover 214 and the touch sensor 114. The liquid may be, for example, water, glycol, or other suitable translucent or transparent liquid. The liquid has a suitable dielectric constant to facilitate detection, by the touch sensor 114, of a touch on the cover 214. The bladder 216 extends across the touch sensor 114 and covers the visible area of the display 112. The cavity, may be thin, for example, about 0.3 millimeters.

The bladder 216 may be disposed on the touch sensor 114 without adhering the bladder 216 to the touch sensor 114. The cover 214 may be disposed on the bladder 216 without adhering the cover 214 to the bladder 216. Thus, the bladder may be disposed between the touch sensor 114 and the cover 214 without adhering to either the touch sensor 114 or the cover 214. The bladder 216 may, however, cling to the cover 214 and/or the touch sensor 114 as a result of material properties, such as static cling or friction, without the use of an adhesive.

The bladder 216 is spaced from the sidewalls 208 to facilitate elastic deformation, or expansion, of the sides 218 of the bladder 216. When a force, such as the force 302 illustrated in FIG. 3, is applied to the cover 214, and the force moves or depresses the cover 214 toward the touch-sensitive display 118, the sides 218 expand. A portion of the volume of liquid filling the cavity is forced toward the sides 218 and the sides 218 elastically deform by extending into the space between the touch-sensitive display 118 and the sidewalls 208 resulting in expanded sides 304. The expanded sides 304 provide a reservoir 306 in fluid communication with the cavity to receive liquid that flows from the cavity into the reservoir 306. Although the volume of liquid in the cavity, between the cover 214 and the touch sensor 114 may be reduced, the cover 214 remains spaced from the touch sensor 114. When the force is discontinued, the bladder 216 returns to the shape of the bladder 216 prior to the application of the force and the liquid returns from the reservoir 306, into the cavity between the cover 214 and the touch sensor 114.

Although the touch-sensitive display 118 is shown as floating with respect to the housing 202 in FIG. 3, the touch-sensitive display 118 may alternatively be fixed in a fixed position with respect to the housing 202.

One or more touches on the cover 214, also known as touch contacts or touch events, may be detected by the touch-sensitive display 118. The processor 102 may determine attributes of the touch, including a location of a touch. Touch location data may include an area of contact or a single point of contact, such as a point at or near a center of the area of contact. A signal is provided to the controller 116 in response to detection of a touch. A touch may be detected from any suitable input member, such as a finger, thumb, appendage, or other objects, for example, a stylus, pen, or other pointer, depending on the nature of the touch-sensitive display 118. The controller 116 and/or the processor 102 may detect a touch by any suitable input member on the cover of the touch-sensitive display 118. Multiple simultaneous touches may be detected.

One or more gestures may also be detected by the touch-sensitive display 118. A gesture, such as a swipe, also known as a flick, is a particular type of touch on a touch-sensitive display 118 and may begin at an origin point and continue to an end point. A gesture may be identified by attributes of the gesture, including the origin point, the end point, the distance traveled, the duration, the velocity, and the direction, for example. A gesture may be long or short in distance and/or duration. Two points of the gesture may be utilized to determine a direction of the gesture.

A front view of an example of the electronic device 100 is shown in FIG. 4. A keyboard 402 is displayed on the touch-sensitive display 118. When a key of the keyboard 402 is selected by a touch on the cover 214, a force imparted on the cover 214 that is sufficient to depress the cover 214 causes expansion of the sides of the bladder 216 as liquid flows from the cavity into the reservoir 306 provided by the expanded sides 304. Although the cover 214 may be depressed, a smaller volume of liquid remains in the cavity, between the cover 214 and the touch sensor 114. Thus, when a force is imparted on the cover, a volume of liquid remains between the cover 214 and the touch sensor 114 and the cover 214 remains spaced from the touch sensor 114. When the force is discontinued, the volume of liquid that flowed into the reservoir 306 returns to the cavity.

Utilizing a bladder between the cover and the touch sensor, the cover may be disposed on the bladder without adhering the cover to the touch sensor. Manufacturing costs may be reduced by not adhering the cover to the touch sensor. Further, the cover may be removed from the remainder of the touch-sensitive display, facilitating replacement of the cover without replacing the touch sensor and the display. The bladder provides a liquid disposed within a cavity between the cover and the touch sensor and a suitable liquid may be utilized to provide a sufficiently high dielectric constant to facilitate detection of a touch on the cover. The bladder also provides cushioning for the cover and the touch sensor and may reduce the ingress of the dust and water between the cover and the touch sensor.

A touch-sensitive display includes a display, a capacitive touch sensor disposed on the display, a cover spaced from the capacitive touch sensor, and a liquid disposed within a cavity between the capacitive touch sensor and the cover. An electronic device includes a touch-sensitive display including a capacitive touch sensor disposed on the display, a cover spaced from the capacitive touch sensor, and a liquid disposed within a cavity between the capacitive touch sensor and the cover, and a processor coupled to the touch-sensitive display.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A touch-sensitive display comprising:
a display;
a capacitive touch sensor disposed on the display;
a cover spaced from the capacitive touch sensor;
a liquid disposed in a cavity between the capacitive touch sensor and the cover.

2. The touch-sensitive display according to claim 1, comprising a bladder disposed between the capacitive touch sensor and the cover, wherein the liquid is disposed within the bladder.

3. The touch-sensitive display according to claim 2, wherein the bladder comprises a silicone bladder.

4. The touch-sensitive display according to claim 1, wherein the liquid comprises water.

5. The touch-sensitive display according to claim 1, comprising a reservoir in fluid communication with the cavity to facilitate flow of the liquid into the reservoir when a force is applied to the cover.

6. The touch-sensitive display according to claim 1, comprising a bladder disposed between the capacitive touch sensor and the cover, wherein the liquid is disposed within the bladder and the bladder is expandable on at least one side to facilitate flow of the liquid when a force is applied to the cover.

7. The touch-sensitive display according to claim 1, wherein the capacitive touch sensor comprises a first set of electrodes and a second set of electrodes separated from the first set of electrodes by a barrier layer.

8. The touch-sensitive display according to claim 1, wherein the capacitive touch sensor comprises a glass sheet including electrodes deposited on at least one side.

9. The touch-sensitive display according to claim 1, comprising a bladder disposed between the capacitive touch sensor and the cover without adhesive, wherein the liquid is disposed within the bladder.

10. An electronic device comprising:
a touch-sensitive display comprising
a display;
a capacitive touch sensor disposed on the display;
a cover spaced from the capacitive touch sensor;
a liquid disposed in a cavity between the capacitive touch sensor and the cover;
at least one processor coupled to the touch-sensitive display.

11. The electronic device according to claim 10, comprising a bladder disposed between the capacitive touch sensor and the cover, wherein the liquid is disposed within the bladder.

12. The electronic device according to claim 11, wherein the bladder comprises a silicone bladder.

13. The electronic device according to claim 10, wherein the liquid comprises water.

14. The electronic device according to claim 10, comprising a reservoir in fluid communication with the cavity to facilitate flow of the liquid into the reservoir when a force is applied to the cover.

15. The electronic device according to claim 10, comprising a bladder disposed between the capacitive touch sensor and the cover, wherein the liquid is disposed within the bladder and the bladder is expandable on at least one side to facilitate flow of the liquid when a force is applied to the cover.

16. The electronic device according to claim 10, wherein the capacitive touch sensor comprises a first set of electrodes and a second set of electrodes separated from the first set of electrodes by a barrier layer.

17. The electronic device according to claim 10, wherein the capacitive touch sensor comprises a glass sheet including electrodes deposited on at least one side.

18. The electronic device according to claim 10, comprising a bladder disposed, between the capacitive touch sensor and the cover, without adhesive, wherein the liquid is disposed within the bladder.
